(19) United States
(12) Patent Application Publication
(10) Pub. No.: US 2025/0360714 A1
(43) Pub. Date: Nov. 27, 2025

(54) LIQUID EJECTING APPARATUS

(71) Applicant: SEIKO EPSON CORPORATION, Tokyo (JP)

(72) Inventor: Ryoji FUJIMORI, SUWA-SHI (JP)

(21) Appl. No.: 19/219,117

(22) Filed: May 27, 2025

(30) Foreign Application Priority Data
May 27, 2024 (JP) 2024-085614

(51) Int. Cl. B41J 2/165; B41J 23/12; B41J 25/00

(52) U.S. Cl. CPC B41J 2/16511; B41J 2/16535; B41J 23/12; B41J 25/001; B41J 2002/16594

(57) ABSTRACT

A liquid ejecting apparatus includes multiple heads configured to eject a liquid onto a medium, carriage configured to incorporate the multiple heads and move the multiple heads along a first direction, a cap configured to receive the liquid discharged from the multiple heads, and a mover configured to move the cap along a second direction that intersects with the first direction in a plan view. The multiple heads include a first head, and a second head arranged with respect to the first head in the first direction and provided at a position different from the first head in a second direction. The mover is configured to position the cap at a first position to cause the cap to receive the liquid discharged from the first head, and position the cap at a second position different from the first position in the second direction to cause the cap to receive the liquid discharged from the second head.

The present application is based on, and claims priority from JP Application Serial Number 2024-085614, filed May 27, 2024, the disclosure of which is hereby incorporated by reference herein in its entirety.

### BACKGROUND

### 1. Technical Field

The present disclosure relates to a liquid ejecting apparatus.

### 2. Related Art

A liquid ejecting apparatus is disclosed, for example, in JP-A-2005-096447, which includes multiple heads configured to eject a liquid, a carriage configured to move the multiple heads along a first direction, and a cap configured to receive the liquid discharged from the multiple heads. In the thus configured liquid ejecting apparatus, the multiple heads are provided so as to be arranged along the first direction, but the multiple heads are provided in some cases at different positions in a second direction that intersects with the first direction in the plan view.

JP-A-2005-096447 is an example of the related art.

In the thus configured liquid ejecting apparatus, however, in which the multiple heads are provided at different positions in the second direction, the liquid is not appropriately received in some cases depending on the positions of the multiple heads.

### SUMMARY

A liquid ejecting apparatus that solves the problem described above includes multiple heads configured to eject a liquid onto a medium; a carriage configured to incorporate the multiple heads and move the multiple heads along a first direction; a cap configured to receive the liquid discharged from the multiple heads; and a mover configured to move the cap along a second direction that intersects with the first direction in a plan view, the multiple heads including a first head and a second head that is arranged with respect to the first head in the first direction and provided at a position different from the first head in the second direction, the mover configured to position the cap at a first position to cause the cap to receive the liquid discharged from the first head, and position the cap at a second position different from the first position in the second direction to cause the cap to receive the liquid discharged from the second head.

### BRIEF DESCRIPTION OF THE DRAWINGS

FIG. 1 is a diagrammatic view showing a liquid ejecting apparatus according to a first embodiment.

FIG. 2 is a diagrammatic view showing multiple heads in the first embodiment.

FIG. 3 is a perspective view showing a moisture retaining cap and a suction cap in the first embodiment.

FIG. 4 is a side view showing the suction apparatus in the first embodiment.

FIG. 5 is a perspective view showing a mover in the first embodiment.

FIG. 6 is a side view showing the mover in the first embodiment.

FIG. 7 is a bottom view showing the mover in the first embodiment.

FIG. 8 is a flowchart showing a suction control process in the first embodiment.

### DESCRIPTION OF EMBODIMENTS

### First Embodiment

An embodiment of a liquid ejecting apparatus and a method of controlling the liquid ejecting apparatus will be described below. In the following description, a direction that intersects with a vertical direction Z is referred to as a scanning direction X, and a direction that intersects with the vertical direction Z and the scanning direction X is referred to as an intersecting direction Y. The direction toward one side in the scanning direction X is referred to as a first scanning direction X1, and the direction toward the other side in the scanning direction X is referred to as a second scanning direction X2. The direction toward one side in the intersecting direction Y is referred to as a first intersecting direction Y1, and the direction toward the other side in the intersecting direction Y is referred to as a second intersecting direction Y2. The upper side in the vertical direction Z is referred to as an upper side Z1, and the lower side in the vertical direction Z is referred to as a lower side Z2. The scanning direction X corresponds to an example of a first direction. The intersecting direction Y corresponds to an example of a second direction. The vertical direction Z corresponds to an example of a third direction.

### Configuration of Liquid Ejecting Apparatus 10

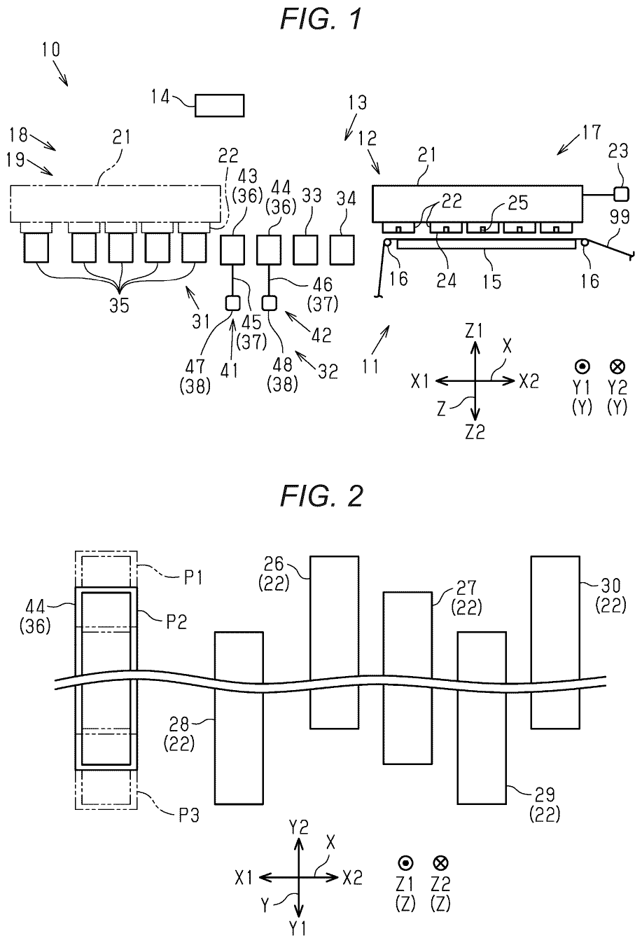

A liquid ejecting apparatus 10 is configured to perform printing on a medium 99 by ejecting a liquid onto the medium 99, as shown in FIG. 1. The liquid may include, for example, ink. The liquid may, for example, be multiple types of liquid having multiple colors. The liquid ejecting apparatus 10 may be an inkjet printer. The liquid ejecting apparatus 10 may include a medium conveyance unit 11, a printing unit 12, a maintenance unit 13, and a controller 14.

### Configuration of Medium Conveyance Unit 11

The medium conveyance unit 11 is configured to convey the medium 99. The medium conveyance unit 11 may include a medium support 15 and multiple conveyance rollers 16. The medium support 15 is configured to support the medium 99. The medium support 15 may be configured to support the conveyed medium 99 from the lower side Z2. The conveyance rollers 16 rotate to convey the medium 99.

The medium conveyance unit 11 may, for example, intermittently convey the medium 99. Specifically, the medium conveyance unit 11 stops conveying the medium 99 during the period for which printing is performed on the medium 99. The medium conveyance unit 11 conveys the medium 99 after the printing is performed on the medium 99. The medium conveyance unit 11 may convey not only an elongated medium 99 but also a cut-sheet-shaped medium 99.

### Configuration of Printing Unit 12

The printing unit 12 is configured to perform printing on the medium 99. The printing unit 12 performs printing on a region of the medium 99 that is the region supported by the medium support 15. The printing unit 12 is configured to perform printing on the medium 99 in a printing region 17. The printing region 17 corresponds to an example of an ejection region to which the liquid is ejected by the printing unit 12.

The printing unit 12 may include a carriage 21, multiple heads 22, and a pressurizer 23. That is, the liquid ejecting apparatus 10 may include the carriage 21, the multiple heads 22, and the pressurizer 23.

The carriage 21 is configured to incorporate the multiple heads 22. The carriage 21 is configured to make a reciprocating motion along the scanning direction X. The carriage 21 thus moves the multiple heads 22 along the scanning direction X. The carriage 21, which makes the reciprocating motion along the scanning direction X, passes through a position where the carriage 21 faces the medium 99. The carriage 21 passes through, for example, a space on the upper side Z1 of the medium support 15.

In the liquid ejecting apparatus 10, the direction in which the carriage 21 moves coincides with the direction in which the medium 99 moves on the medium support 15. The liquid ejecting apparatus 10 is a lateral printer. The carriage 21 is controlled by the controller 14. That is, the controller 14 controls the carriage 21.

The printing unit 12 may include, for example, five heads 22 as the multiple heads 22. The multiple heads 22 may be arranged in the scanning direction X. The multiple heads 22 have the same configuration. One of the heads 22 will therefore be described below.

The head 22 is configured to eject the liquid. The head 22 in the present embodiment ejects the liquid in the vertical direction Z. The head 22 has a nozzle surface 24. A nozzle 25 is formed at the nozzle surface 24. The nozzle surface 24 is a surface via which one or more nozzles 25 open. The head 22 ejects the liquid from the nozzle 25.

The multiple heads 22 are incorporated in the carriage 21. The multiple heads 22 are each configured to eject the liquid onto the medium 99. The multiple heads 22 are each configured to eject the liquid in the printing region 17 along the scanning direction X. The multiple heads 22 print an image on the medium 99 by discharging the liquid onto the medium 99. The multiple heads 22 may eject the same type of liquid or different types of liquid. For example, four heads 22 may eject multiple types of ink having different colors, and one of the heads 22 may eject a reaction liquid that aggregates the multiple types of ink.

The head 22 is, for example, a portion of a line head capable of simultaneously ejecting the liquid onto the medium 99 along the intersecting direction Y. The head 22 is movable in the scanning direction X. The head 22 makes a reciprocating motion in the scanning direction X along with the carriage 21. The head 22 can eject the liquid over an entire region of the medium 99 that is the region supported by the medium support 15.

The pressurizer 23 is coupled to the head 22. For example, the pressurizer 23 pressurizes the interior of each of the multiple heads 22. The printing unit 12 may include multiple pressurizers 23. For example, the printing unit 12 may include the pressurizer 23 for each of the heads 22.

The pressurizer 23 is, for example, a pump. The pressurizer 23 pressurizes the interior of the head 22 to discharge the liquid from the head 22. That is, the pressurizer 23 pressurizes and discharges the liquid from the nozzle 25 by pressurizing the interior of the head 22. Pressurizing and discharging the liquid is also referred to as pressure cleaning. The pressure cleaning is maintenance in which the liquid is forcibly discharged from the nozzle 25 to discharge air bubbles, foreign substances, and the like from the nozzle 25 along with the liquid in the head 22.

### Configuration of Maintenance Unit 13

The maintenance unit 13 is configured to perform maintenance of the multiple heads 22. The maintenance unit 13 is provided in a maintenance region 18 different from the printing region 17. The maintenance region 18 may be located at a position shifted from the printing region 17 in the first scanning direction X1.

The maintenance unit 13 may include a moisture retainer 31, a cleaner 32, a wiper 33, and a flusher 34. In the maintenance unit 13, the moisture retainer 31, the cleaner 32, the wiper 33, and the flusher 34 may be arranged in this order in the second scanning direction X2.

The moisture retainer 31 may include one or more moisture retaining caps 35. The moisture retainer 31 may include moisture retaining caps 35 the number of which is equal to the number of the heads 22. The moisture retainer 31 may include, for example, five moisture retaining caps 35.

The multiple moisture retaining caps 35 are provided so as to be arranged along the scanning direction X. The multiple moisture retaining caps 35 are provided at positions where the multiple moisture retaining caps 35 face the respective multiple heads 22. The moisture retaining caps 35 come into contact with the heads 22 to form spaces that communicate with the nozzles 25. The moisture retaining caps 35 cap the heads 22 located at a standby position 19. The moisture retaining caps 35, which cap the heads 22, keep the nozzles 25 moisturized.

The multiple moisture retaining caps 35 are thus configured to cover the respective multiple heads 22. Any two of the multiple moisture retaining caps 35 correspond to an example of a first moisture retaining cap and a second moisture retaining cap.

The cleaner 32 performs suction cleaning of each of the heads 22. The suction cleaning is cleaning in which the liquid is suctioned from the head 22. The cleaner 32 cleans the multiple heads 22 separately from each other.

The cleaner 32 may include one or more suction caps 36, one or more channels 37, and one or more suction pumps 38. The suction caps 36 are provided at positions shifted toward the printing region 17 from the moisture retaining caps 35 in the scanning direction X in the maintenance region 18. The moisture retaining caps 35 and the suction caps 36 are provided so as to be arranged in the scanning direction X in the maintenance region 18 outside the printing region 17. The suction caps 36 come into contact with the heads 22 to form spaces that communicate with the nozzles 25. The suction caps 36 cap the heads 22.

The channels 37 are configured to couple the suction caps 36 to the suction pumps 38. The suction pumps 38 are configured to suction the liquid inside the suction caps 36 via the channels 37. The liquid suctioned by the suction pumps 38 is discharged as waste liquid to a waste liquid container that is not shown.

The cleaner 32 performs the suction cleaning by suctioning the interior of each of the suction caps 36 to generate a negative pressure. Performing the suction cleaning on any of the heads 22 that has not been filled with the liquid allows the head 22 to be filled with the liquid. Performing the suction cleaning on any of the heads 22 that has been filled with the liquid allows air bubbles, foreign substances, and the like in the head 22 to be discharged. As described above, the suction caps 36 are configured to receive the liquid discharged from each of the multiple heads 22 as a result of the suction performed by the suction pumps the suction cleaning.

The cleaner 32 includes a first cleaner 41 and a second cleaner 42. The first cleaner 41 and the second cleaner 42 are provided side by side in the scanning direction X. The first cleaner 41 is located at a position shifted from the second cleaner 42 in the first scanning direction X1.

The first cleaner 41 is configured to perform the suction cleaning on the head 22 that ejects the reaction liquid out of the multiple heads 22. The first cleaner 41 may include a first suction cap 43, a first channel 45, and a first suction pump 47. The first suction cap 43 is configured to receive the reaction liquid discharged from the head 22. The reaction liquid corresponds to an example of a second liquid.

The second cleaner 42 is configured to perform the suction cleaning separately on the heads 22 that eject the multiple types of ink having the multiple colors out of the multiple heads 22. The second cleaner 42 may include a second suction cap 44, a second channel 46, and a second suction pump 48. The second suction cap 44 is configured to receive the ink discharged from the multiple heads 22. The ink corresponds to an example of a first liquid.

The suction caps 36 include the first suction cap 43 and the second suction cap 44. The channels 37 include the first channel 45 and the second channel 46. The suction pumps 38 include the first suction pump 47 and the second suction pump 48. As described above, the liquid ejecting apparatus 10 may include the first suction cap 43, the second suction cap 44, the first channel 45, the second channel 46, the first suction pump 47, and the second suction pump 48.

The wiper 33 can wipe the nozzle surface 24 at a position where the wiper 33 faces any of the heads 22. The wiper 33 performs maintenance of the head 22 by wiping the waste liquid from the nozzle surface 24. The wiper 33 performs wiping in which the wiper 33 wipes the nozzle surface 24.

The flusher 34 is configured to receive the liquid discharged from the nozzle 25. The flusher 34 may receive the liquid discharged from the head 22 by the pressurizer 23. That is, the flusher 34 may receive the liquid discharged by the pressure cleaning.

The flusher 34 may receive the liquid ejected by dummy ejection. The dummy ejection is the operation of ejecting the liquid from the nozzle 25 to suppress clogging of the each of the nozzles 25. The dummy ejection is also referred to as flushing. The dummy ejection, for example, discharges liquid having increased viscosity from the nozzle 25. The flusher 34 receives the liquid discharged from the head 22 facing the flusher 34.

### Configuration of Controller 14

The controller 14 harmoniously controls the liquid ejecting apparatus 10. The controller 14 controls various types of operation performed by the liquid ejecting apparatus 10. The controller 14 can be configured as x: one or more processors that carry out various processes in accordance with a computer program, B: one or more dedicated hardware circuits that carry out at least some of the various processes, or y: a circuit including a combination of thereof. The hardware circuit is, for example, an application specific integrated circuit. The processor includes a CPU and a memory such as a RAM and a ROM, and the memory stores program codes or instructions configured to cause the CPU to carry out the processes. The memory, that is, a computer-readable medium includes any readable medium that can be accessed by a general-purpose or dedicated computer.

### Arrangement of Heads 22

The multiple heads 22 include a first head 26 and a second head 27, as shown in FIG. 2. The multiple heads 22 may include a third head 28, a fourth head 29, and a fifth head 30. The multiple heads 22 are arranged in the second scanning direction X2 in the following order: the third head 28; the first head 26; the second head 27; the fourth head 29; and the fifth head 30. That is, the first head 26, the second head 27, the third head 28, the fourth head 29, and the fifth head 30 are provided so as to be arranged in the scanning direction X.

The multiple heads 22 have the same size. That is, the multiple heads 22 have the same length in the scanning direction X. The multiple heads 22 have the same length in the intersecting direction Y.

The third head 28 is configured to eject the reaction liquid as the liquid. The first head 26, the second head 27, the fourth head 29, and the fifth head 30 are configured to eject the multiple types of ink having the multiple colors as the liquid.

For example, the first head 26 may be configured to eject black ink. For example, the second head 27 may be configured to eject cyan ink and gray ink. For example, the fourth head 29 may be configured to eject magenta ink and orange ink. For example, the fifth head 30 may be configured to eject yellow ink and overprint varnish.

The first head 26, the second head 27, the fourth head 29, and the fifth head 30 are provided at equal intervals in the intersecting direction Y, and the intervals may be shorter than the interval between the first head 26 and the third head 28.

The multiple heads 22 are provided at different positions in the intersecting direction Y as compared with the heads 22 adjacent to each other in the scanning direction X. Density unevenness on the medium can thus be suppressed. For example, the first head 26 and the fifth head 30 are positioned so as to be separate from the second head 27 as a reference by a predetermined distance in the second intersecting direction Y2. For example, the third head 28 and the fourth head 29 are positioned so as to be separate from the second head 27 as the reference by a predetermined distance in the first intersecting direction Y1. As described above, the first head 26 and the second head 27 are provided at different positions in the intersecting direction Y.

### Configuration of Cleaner 32

The second suction cap 44 is configured to move in the intersecting direction Y. The second suction cap 44 is movable along the intersecting direction Y to any of a first position P1, a second position P2, and a third position P3. The first position P1, the second position P2, and the third position P3 are different positions in the intersecting direction Y. The second position P2 is shifted from the first position P1 in the first intersecting direction Y1. The third position P3 is shifted from the second position P2 in the first intersecting direction Y1.

When disposed at the first position P1, the second suction cap 44 can face the first head 26 in the vertical direction Z and can receive the liquid discharged from the first head 26. When disposed at the first position P1, the second suction cap 44 can face the fifth head 30 in the vertical direction Z and can receive the liquid discharged from the fifth head 30. When disposed at the second position P2, the second suction cap 44 can face the second head 27 in the vertical direction Z and can receive the liquid discharged from the second head 27. When disposed at the third position P3, the second suction cap 44 can face the fourth head 29 in the vertical direction Z and can receive the liquid discharged from the fourth head 29. The reference position of the second suction cap 44 may be the second position P2.

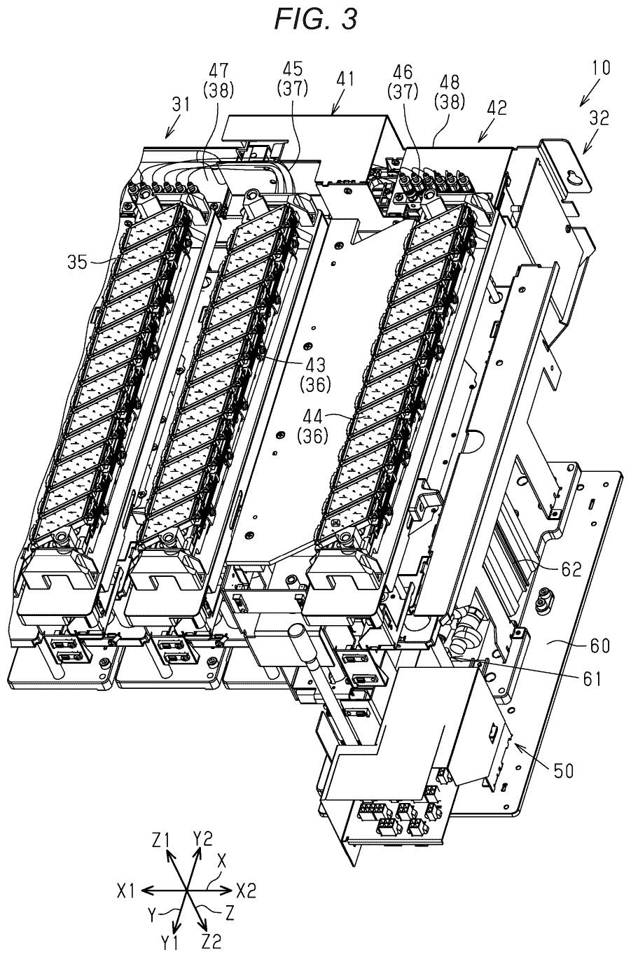

The first cleaner 41 may be provided between the second cleaner 42 and the moisture retainer 31 in the scanning direction X, as shown in FIG. 3. The first suction cap 43 may be provided between the second suction cap 44 and the moisture retaining caps 35 in the scanning direction X.

The second cleaner 42 includes a mover 50. That is, the liquid ejecting apparatus 10 includes the mover 50. The mover 50 is configured to move the second suction cap 44 in the intersecting direction Y. The first suction cap 43 is configured not to move in the intersecting direction Y.

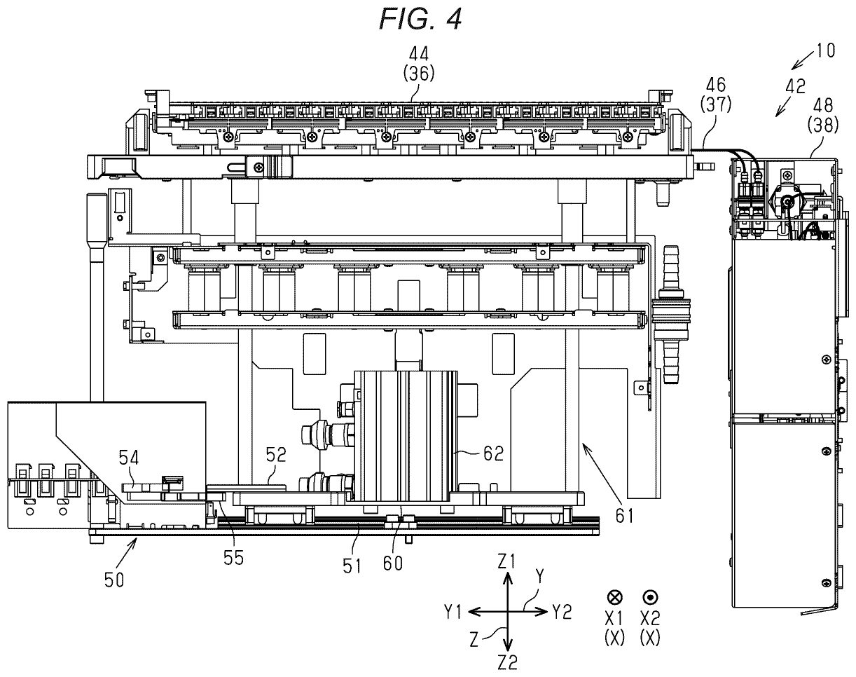

The second cleaner 42 includes a base 60, a support 61, and an elevator 62, as shown in FIG. 4. The support 61 is provided at the base 60. The support 61 is configured to support the second suction cap 44.

The base 60 is movable along the intersecting direction Y with the aid of the mover 50. That is, the second suction cap 44 is movable along the intersecting direction Y with the aid of the mover 50. The elevator 62 lifts and lowers the second suction cap 44 along the vertical direction Z. The elevator 62 is controlled by the controller 14. That is, the controller 14 controls the elevator 62.

### Configuration of Mover 50

The mover 50 includes a guide rail 51. The guide rail 51 extends in the intersecting direction Y. The guide rail 51 is configured to support the base 60 from the lower side Z2. The guide rail 51 guides the base 60 to be movable along the intersecting direction Y. That is, the guide rail 51 is configured to guide the movement of the second suction cap 44 in the intersecting direction Y.

The guide rail 51 is provided at a position where the guide rail 51 overlaps with the second suction cap 44 in the plan view. In detail, the guide rail 51 is provided at a position where the guide rail 51 overlaps with a portion of the second suction cap 44 in the plan view, but may be provided at a position where the guide rail 51 overlaps with the entire second suction cap 44 in the plan view.

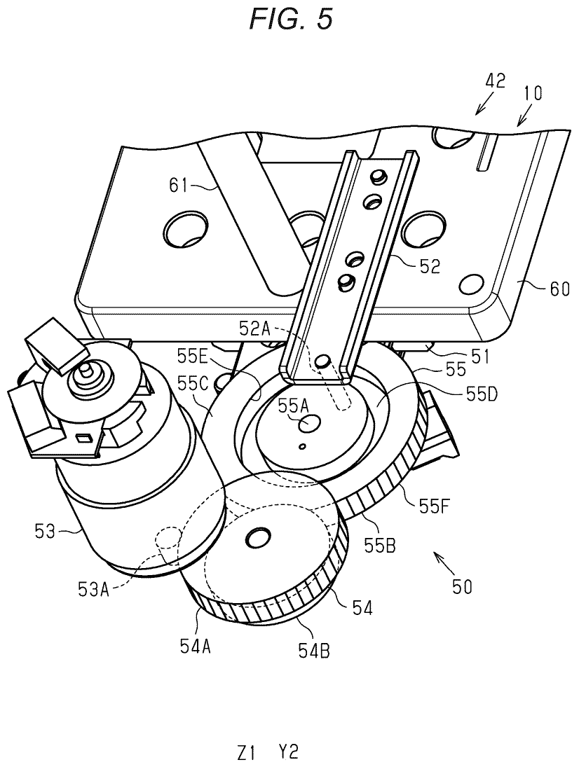

The mover 50 includes an arm 52, a driver 53, a gear 54, and a cam 55, as shown in FIG. 5. The arm 52 is fixed to the base 60. The arm 52 extends along the intersecting direction Y. The arm 52 may include an engagement section 52A engageable with the cam 55. The engagement section 52A is provided at an end portion of the arm 52 in the first intersecting direction Y1. The engagement section 52A may be a protrusion protruding toward the lower side Z2.

The driver 53 is a drive source for moving the second suction cap 44 in the intersecting direction Y by rotating the gear 54 and the cam 55, as shown in FIGS. 5 to 7. The driver 53 may be a motor. The driver 53 includes a driving gear 53A. The driving gear 53A transmits a driving force to the gear 54. The driver 53 is controlled by the controller 14. That is, the controller 14 controls the mover 50.

The gear 54 and the cam 55 are members that move the second suction cap 44 in the intersecting direction Y. The gear 54 is rotated by the driving force from the driver 53. The gear 54 is configured to transmit the driving force from the driver 53 to the cam 55.

The gear 54 may be a double gear. The gear 54 may include an upper gear 54A and a lower gear 54B. The upper gear 54A may have a diameter greater than that of the lower gear 54B. The upper gear 54A may have a diameter greater than that of the lower gear 54B. The upper gear 54A and the lower gear 54B may have different gear ratios. The upper gear 54A and the lower gear 54B are rotatable as a unit. The upper gear 54A receives the driving force from the driving gear 53A of the driver 53. The lower gear 54B transmits the driving force from the driver 53 to the cam 55.

The cam 55 rotates around a rotary shaft 55A by the driving force transmitted from the driver 53 via the gear 54. The rotary shaft 55A extends along the vertical direction Z. The cam 55 includes a gear section 55B. The gear section 55B is provided around the outer circumference of the cam 55. The cam 55 receives the driving force from the lower gear 54B via the gear section 55B.

The cam 55 may be a rotary grooved cam. The cam 55 has a groove 55D at an upper surface 55C. The groove 55D is recessed from the upper surface 55C. The groove 55D is configured to be eccentric with respect to the rotary shaft 55A of the cam 55.

The groove 55D is so shaped that the engagement section 52A can be inserted into the groove 55D. When the cam 55 rotates around the rotary shaft 55A with the engagement section 52A inserted into the groove 55D, an inner wall 55E, which forms the groove 55D, comes into contact with the engagement section 52A. When the inner wall 55E presses the engagement section 52A in the intersecting direction Y with the inner wall 55E being in contact with the engagement section 52A, the base 60 moves along with the arm 52 in the intersecting direction Y. The second suction cap 44 thus moves in the intersecting direction Y.

When the second suction cap 44 receives the liquid discharged from the first head 26, the mover 50 positions the second suction cap 44 at the first position P1. When the second suction cap 44 receives the liquid discharged from the second head 27, the mover 50 positions the second suction cap 44 at the second position P2. When the second suction cap 44 receives the liquid discharged from the fourth head 29, the mover 50 positions the second suction cap 44 at the third position P3. When the second suction cap 44 receives the liquid discharged from the fifth head 30, the mover 50 positions the second suction cap 44 at the first position P1.

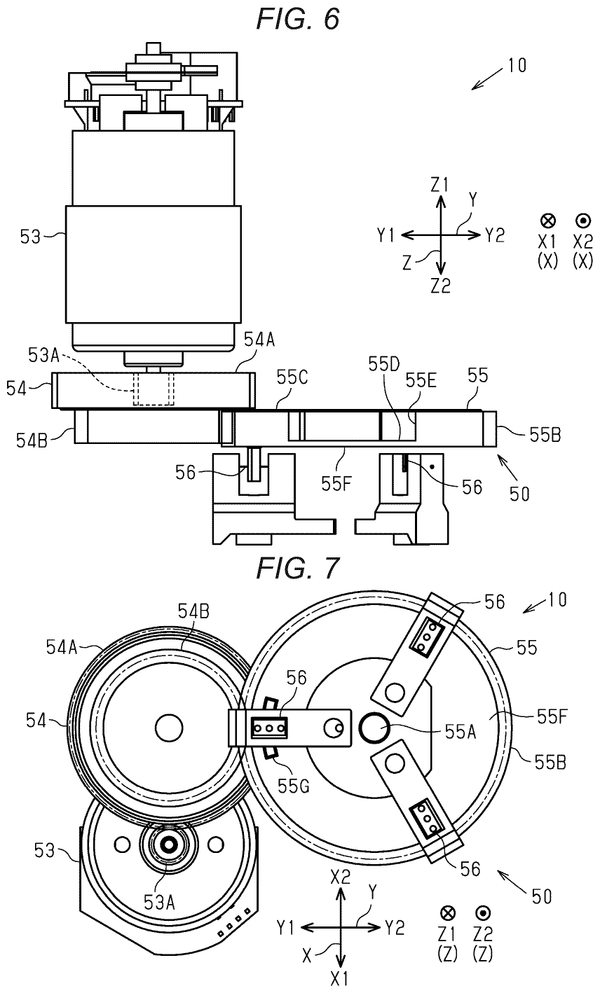

The liquid ejecting apparatus 10 includes a detector 56, as shown in FIGS. 6 and 7. The liquid ejection apparatus 10 may include multiple detectors 56. The detector 56 is configured to detect the angle of rotation of the cam 55. The detector 56 may be a sensor. The detector 56 may be a contact sensor or a non-contact sensor. The detector 56 is provided on the side facing a bottom surface 55F of the cam 55.

The detector 56 is configured to detect a detection target section 55G provided at the bottom surface 55F of the cam 55. The detection target section 55G may be convex with respect to the bottom surface 55F, or may be concave with respect to the bottom surface 55F. The detection target section 55G may be a region having reflectance different from that of the bottom surface 55F.

The detector 56 detects the position of the second suction cap 44 by detecting the angle of rotation of the cam 55. In particular, the detector 56 detects whether the position of the second suction cap 44 is the first position P1, the second position P2, or the third position P3 by detecting the angle of rotation of the cam 55. The detector 56 outputs a detection signal indicating the result of the detection to the controller 14.

Based on the detection signal from the detector 56, the controller 14 can identify which of the first position P1, the second position P2, and the third position P3 to which the second suction cap 44 has moved. The controller 14 then controls the mover 50 to move the second suction cap 44 based on the result of the detection performed by the detector 56. That is, the second suction cap 44 is moved by the mover 50 based on the result of the detection performed by the detector 56.

In the present embodiment, the first suction cap 43 is an element separate from the second suction cap 44, but may be configured to be lifted and lowered in the vertical direction Z, as the second suction cap 44. In the present embodiment, the moisture retaining caps 35 are elements separate from the second suction cap 44, but may be configured to be lifted and lowered in the vertical direction Z, as the second suction cap 44.

### Suction Control Process

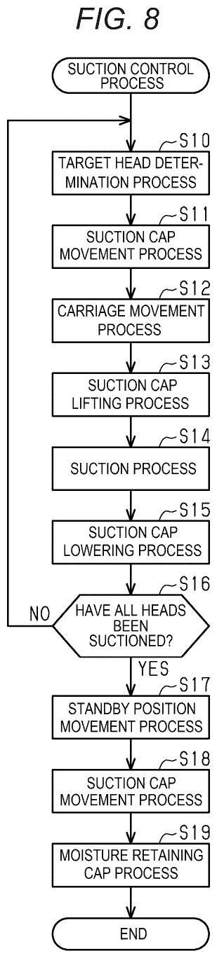

A suction control process will be described below with reference to FIG. 8. The suction control process is a process carried out by the controller 14 when a condition under which the suction cleaning of the heads 22 starts is satisfied.

In step S10, the controller 14 carries out a target head determination process, as shown in FIG. 8. In this process, the controller 14 determines the head 22 to be subjected to the suction cleaning out of the multiple heads 22. In the following description, the suction cleaning target is referred to as a suction target in some cases. For example, the controller 14 determines the second head 27 as the suction target head 22 after the suction cleaning of the first head 26 is completed.

In step S11, the controller 14 carries out a suction cap movement process. In this process, the controller 14 controls the mover 50 to move the second suction cap 44 to a position corresponding to the suction target head 22. That is, the controller 14 controls the mover 50 to move the second suction cap 44 to a position where the second suction cap 44 faces the suction target head 22 in the vertical direction Z. For example, when the second head 27 is the suction target, the controller 14 causes the mover 50 to move the second suction cap 44 to the second position P2 corresponding to the second head 27. For example, when the third head 28 is the suction target, the controller 14 does not cause the mover 50 to move the second suction cap 44.

In step S12, the controller 14 carries out a carriage movement process. In this process, the controller 14 moves the carriage 21 in the scanning direction X in such a way that the suction cap 36 and the suction target head 22 face each other in the vertical direction Z. For example, when the second head 27 is the suction target, the controller 14 moves the carriage 21 in the scanning direction X in such a way that the second suction cap 44 and the second head 27, which is the suction target, face each other in the vertical direction Z. For example, when the third head 28 is the suction target, the controller 14 moves the carriage 21 in the scanning direction X in such a way that the first suction cap 43 and the third head 28, which is the suction target, face each other in the vertical direction Z.

In step S13, the controller 14 carries out a suction cap lifting process. In this process, the controller 14 controls the suction cap 36 to be lifted so as to cover the suction target head 22. For example, when the second head 27 is the suction target, the controller 14 controls the elevator 62 to lift the second suction cap 44 so as to cover the second head 27 in the vertical direction Z. For example, when the third head 28 is the suction target, the controller 14 controls the elevator 62 to lift the first suction cap 43 so as to cover the third head 28 in the vertical direction Z.

In step S14, the controller 14 carries out a suction process. In this process, the controller 14 drives the suction pump 38 in such a way that the suction cap 36 receives the liquid discharged from the suction target head 22. For example, when the second head 27 is the suction target, the controller 14 drives the second suction pump 48 in such a way that the second suction cap 44 receives the liquid discharged from the second head 27. For example, when the third head 28 is the suction target, the controller 14 drives the first suction pump 47 in such a way that the first suction cap 43 receives the liquid discharged from the third head 28.

In step S15, the controller 14 carries out a suction cap lowering process. In this process, the controller 14 controls the elevator 62 to lower the suction cap 36 so as to move away from the suction target head 22. For example, when the second head 27 is the suction target, the controller 14 controls the elevator 62 to lower the second suction cap 44 so as to move away from the second head 27 in the vertical direction Z. For example, when the third head 28 is the suction target, the controller 14 controls the elevator 62 to lower the first suction cap 43 so as to move away from the third head 28 in the vertical direction Z.

In step S16, the controller 14 determines whether the suction cleaning of all the heads 22 is completed. When the controller 14 determines that the suction cleaning of all the heads 22 is not completed, the controller 14 transitions to the process in step S10 again. When the controller 14 determines that the suction cleaning of all the heads 22 has been completed, the controller 14 transitions to the process in step S17. As described above, the controller 14 repeatedly performs the suction cleaning of the individual multiple heads 22 until the suction cleaning of all the heads 22 is completed.

As a specific example, the controller 14 moves the carriage 21 in such a way that the first suction cap 43 faces the third head 28 in the vertical direction Z. In this state, the controller 14 causes the elevator 62 to lift the first suction cap 43 so as to cover the third head 28. The controller 14 then causes the first suction cap 43 to receive the liquid suctioned by the first suction pump 47. The controller 14 causes the elevator 62 to lower the first suction cap 43.

The controller 14 causes the mover 50 to position the second suction cap 44 at the first position P1 along the intersecting direction Y. The controller 14 moves the carriage 21 along the scanning direction X in such a way that the second suction cap 44 faces the first head 26 in the vertical direction Z.

In this state, the controller 14 causes the elevator 62 to lift the second suction cap 44 so as to cover the first head 26. The controller 14 then causes the second suction cap 44 to receive the liquid suctioned by the second suction pump 48. The controller 14 causes the elevator 62 to lower the second suction cap 44.

The controller 14 then positions the second suction cap 44 at the second position P2 along the intersecting direction Y. The controller 14 moves the carriage 21 along the scanning direction X in such a way that the second suction cap 44 faces the second head 27 in the vertical direction Z. In this state, the controller 14 causes the elevator 62 to lift the second suction cap 44 so as to cover the second head 27. The controller 14 then causes the second suction cap 44 to receive the liquid suctioned by the second suction pump 48. The controller 14 causes the elevator 62 to lower the second suction cap 44.

The controller 14 then causes the mover 50 to position the second suction cap 44 at the third position P3 along the intersecting direction Y. The controller 14 moves the carriage 21 along the scanning direction X in such a way that the second suction cap 44 faces the fourth head 29 in the vertical direction Z.

In this state, the controller 14 causes the elevator 62 to lift the second suction cap 44 so as to cover the fourth head 29. The controller 14 then causes the second suction cap 44 to receive the liquid suctioned by the second suction pump 48. The controller 14 causes the elevator 62 to lower the second suction cap 44.

The controller 14 then causes the mover 50 to position the second suction cap 44 at the first position P1 along the intersecting direction Y. The controller 14 moves the carriage 21 along the scanning direction X in such a way that the second suction cap 44 faces the fifth head 30 in the vertical direction Z.

In this state, the controller 14 causes the elevator 62 to lift the second suction cap 44 so as to cover the fifth head 30. The controller 14 then causes the second suction cap 44 to receive the liquid suctioned by the second suction pump 48. The controller 14 causes the elevator 62 to lower the second suction cap 44.

In step S17, the controller 14 carries out a standby position movement process. In this process, the controller 14 moves the carriage 21 to the standby position 19 along the scanning direction X. The multiple heads 22 are therefore located at positions where the heads 22 face the respective moisture retaining caps 35 in the vertical direction Z.

In step S18, the controller 14 carries out a suction cap movement process. In this process, the controller 14 controls the mover 50 to move the second suction cap 44 to the second position P2, which is the reference position, along the intersecting direction Y.

In step S19, the controller 14 carries out a moisture retaining cap process. In this process, the controller 14 may control the elevator 62 to lift the moisture retaining caps 35 so as to cover the multiple heads 22.

### Effects and Advantages of First Embodiment

Effects and advantages of the first embodiment will be described.
(1) Even when the first head 26 and the second head 27 are arranged in the scanning direction X and provided at different positions in the intersecting direction Y, the second suction cap 44 is movable along the intersecting direction Y. Positioning the second suction cap 44 at the first position P1 along the intersecting direction Y allows the second suction cap 44 to appropriately receive the liquid discharged from the first head 26. Positioning the second suction cap 44 at the second position P2 along the intersecting direction Y allows the second suction cap 44 to appropriately receive the liquid discharged from the second head 27. The liquid can therefore be appropriately received by moving the second suction cap 44 along the intersecting direction Y.
(2) The second suction cap 44 configured to receive the liquid suctioned by the second suction pump 48 can be moved along the intersecting direction Y. The liquid can therefore be appropriately received by moving the second suction cap 44 along the intersecting direction Y.
(3) In the scanning direction X, the region where the second suction cap 44 is provided is located between the printing region 17 and the region where the moisture retaining caps 35 are provided. The step of suctioning the liquid discharged from the first head 26 and the second head 27 can thus be efficiently executed between the step of ejecting the liquid from the first head 26 and the second head 27 and the step of keeping the first head 26 and the second head 27 moisturized. The liquid can therefore be efficiently and appropriately received.
(4) The controller 14 moves the carriage 21 in such a way that the second suction cap 44 is located at the first position P1 and the second suction cap 44 faces the first head 26 in the vertical direction Z. The controller 14 then causes the elevator 62 to lift the second suction cap 44 so as to cover the first head 26, and then causes the second suction cap 44 to receive the liquid suctioned by the second suction pump 48. Thereafter, the controller 14 causes the elevator 62 to lower the second suction cap 44 in the vertical direction Z, then moves the carriage 21 in such a way that the second suction cap 44 is located at the second position P2 and the second suction cap 44 faces the second head 27. The controller 14 then causes the elevator 62 to lift the second suction cap 44 so as to cover the second head 27. According to the configuration described above, the step of suctioning the liquid discharged from the first head 26 and the step of suctioning the liquid discharged from the second head 27 can be efficiently executed. The liquid can therefore be efficiently and appropriately received.
(5) Using the first suction cap 43 and the second suction cap 44 allows separate reception of the ink discharged from the first head 26 and the second head 27 and the reaction liquid discharged from the third head 28. Therefore, even when the ink and the reaction liquid are received, the liquid can be appropriately received.
(6) The guide rail 51 is provided at a position where the guide rail 51 overlaps with the second suction cap 44 in the plan view. The thus provided guide rail 51, which moves the second suction cap 44 along the intersecting direction Y, can suppress an increase in the size of the liquid ejecting apparatus 10 and can cause the second suction cap 44 to appropriately receive the liquid.
(7) The second suction cap 44 is moved based on the result of the detection of the position of the second suction cap 44. The liquid can therefore be appropriately received by precisely moving the second suction cap 44 along the intersecting direction Y.

### Variations

The present embodiment can be changed and implemented as will be described below. The present embodiment and the following variations can be implemented in the form of a combination thereof as long as there is no technical contradiction.
The detector 56 may detect the position of the second suction cap 44 by detecting the position of a member other than the cam 55. For example, the detector 56 may detect the position of the second suction cap 44 by detecting the position of the base 60. For example, the detector 56 may detect the position of the second suction cap 44 itself. The controller 14 may detect the position of the second suction cap 44 based on the detection signal from the detector 56 and a drive signal from the driver 53.
The cam 55 may be any cam. For example, the cam 55 may be a rotary plate cam. In this case, the mover 50 may include an urging member that urges the base 60 with respect to the cam 55.
The mover 50 only needs to include any driving force transmitter that transmits the driving force from the driver 53 to the second suction cap 44. That is, as long as the driving force transmitter can transmit the driving force from the driver 53 to the second suction cap 44, the driving force transmitter may not include at least any of the arm 52, the gear 54, and the cam 55, or may include any other member.
When the second suction cap 44 performs the suction cleaning, the controller 14 may start the movement of the carriage 21 after starting the movement of the second suction cap 44. When the second suction cap 44 performs the suction cleaning, the controller 14 may start the movement of the carriage 21 before the starting the movement of the second suction cap 44. When the second suction cap 44 performs the suction cleaning, the controller 14 may start the movement of the carriage 21 and start the movement of the second suction cap 44 at the same time. That is, when the second suction cap 44 performs the suction cleaning, the controller 14 may cause the elevator 62 to lift the second suction cap 44 with the movement of both the second suction cap 44 and the carriage 21 completed.
The second suction cap 44 may be moved to a fourth position other than the first position P1, the second position P2, and the third position P3. That is, the second suction cap 44 may be moved to four or more positions so as to cover the multiple heads 22 provided at different positions in the intersecting direction Y.
The second suction cap 44 may not be moved to the third position P3. That is, the second suction cap 44 may be moved to at least two positions so as to cover the multiple heads 22 provided at different positions in the intersecting direction Y.
The reference position of the second suction cap 44 may not be the second position P2, and may, for example, be the first position P1, the third position P3, or a position other than the first position P1, the second position P2, and the third position P3. When the reference position of the second suction cap 44 is the first position P1, the controller 14 may not carry out the suction cap movement process in step S18.
The channels 37 and the suction pumps 38 only need to be capable of separately suctioning the first suction cap 43 and the second suction cap 44. For example, the suction pumps 38 may be configured with any one of the first suction pump 47 and the second suction pump 48. That is, the suction pumps 38 may be configured with one pump that separately suctions the first suction cap 43 and the second suction cap 44. In this case, for example, the channels 37 may include a selector valve and a common channel. The common channel is a channel that couples the first channel and the second channel to the one pump. The selector valve is a valve that switches a state in which the first channel is coupled to the common channel to a state in which the second channel is coupled to the common channel and vice versa.
The moisture retaining caps 35 are provided at different positions in the intersecting direction Y so as to correspond to the respective multiple heads 22, but not necessarily. The moisture retaining caps 35 may be provided at the same position in the intersecting direction Y as long as the moisture retaining caps 35 can cover the respective multiple heads 22.
The second suction cap 44 may be provided between the moisture retaining caps 35 and the first suction cap 43 in the scanning direction X. That is, the second suction cap 44 may be provided adjacent to the moisture retaining caps 35 in the scanning direction X as long as the second suction cap 44 remains in the maintenance region 18. The second suction cap 44 may be provided at a position shifted from the moisture retaining caps 35 in the first scanning direction X1.
The first suction cap 43 may be movable in the intersecting direction Y. The first suction cap 43 may be configured to receive the liquid discharged from two or more heads arranged in the scanning direction X and provided at different positions in the intersecting direction Y.
The liquid ejecting apparatus 10 may not include the first cleaner 41 but may include the second cleaner 42. That is, the liquid ejecting apparatus 10 may not include the first suction cap 43 but may include the second suction cap 44. The liquid ejecting apparatus 10 may include a third suction cap in addition to the first suction cap 43 and the second suction cap 44.
The target moved by the mover 50 in the intersecting direction Y may not be the suction caps. The target moved by the mover 50 in the intersecting direction Y may, for example, be a cap that receives the liquid discharged from the multiple heads 22 by the pressure cleaning. That is, the liquid ejecting apparatus 10 may include a cap that is moved by the mover 50 in the intersecting direction Y.
The medium may be a sheet of paper, a film or a sheet made of resin, a film made of a composite of resin and metal, a laminate film, a woven fabric, a nonwoven fabric, metal foil, a metal film, a ceramic sheet, clothing, or the like.
Any liquid can be selected as the liquid as long as the selected liquid adheres to the medium and can perform recording on the medium. It is assumed that the ink, for example, includes ink in which particles of a functional material made of a solid substance such as pigment or metal particles are dissolved, dispersed, or mixed in a solvent, and that the ink encompasses various compositions such as aqueous ink, oil-based ink, gel ink, and hot melt ink.
The liquid ejecting apparatus 10 is not limited to an inkjet printer and may be a dot impact printer. The liquid ejecting apparatus 10 may not be a lateral printer that conveys the medium 99 in the scanning direction X and may, for example, be a serial printer that conveys the medium 99 in the intersecting direction Y.
The expression “at least one of” used in the present specification means one or more of desired choices. As an example, the expression “at least one of” used in the present specification means only one choice or both of two choices when the number of choices is two. As another example, the expression “at least one of” used in the present specification means only one choice or a combination of any two or more choices when the number of the choices is three or more.

### Additional Remarks

Technical ideas grasped from the embodiment and the variations thereof described above, and the effects and advantages thereof will be described below. The technical ideas and the effects and advantages thereof can be combined with each other as long as there is no technical contradiction.
(A) A liquid ejecting apparatus includes multiple heads configured to eject a liquid onto a medium; a carriage configured to incorporate the multiple heads and move the multiple heads along a first direction; a cap configured to receive the liquid discharged from the multiple heads; and a mover configured to move the cap along a second direction that intersects with the first direction in a plan view, the multiple heads including a first head and a second head that is arranged with respect to the first head in the first direction and provided at a position different from the first head in the second direction, the mover configured to position the cap at a first position to cause the cap to receive the liquid discharged from the first head, and position the cap at a second position different from the first position in the second direction to cause the cap to receive the liquid discharged from the second head.

According to the configuration described above, even when the liquid ejecting apparatus includes the first head and the second head that are arranged in the first direction and provided at different positions in the second direction, the cap is movable along the second direction. Positioning the cap at the first position along the second direction allows the cap to appropriately receive the liquid discharged from the first head. Positioning the cap at the second position along the second direction allows the cap to appropriately receive the liquid discharged from the second head. The liquid can therefore be appropriately received by moving the cap along the second direction.
(B) The liquid ejecting apparatus described above may further include a suction pump configured to suction the liquid inside the cap; and a channel configured to couple the cap to the suction pump, and the cap may be a suction cap configured to receive the liquid suctioned by the suction pump.

According to the configuration described above, the suction cap configured to receive the liquid suctioned by the suction pump can be moved along the second direction. The liquid can therefore be appropriately received by moving the suction cap along the second direction.
(C) The liquid ejecting apparatus described above may include a first moisture retaining cap configured to cover the first head; and a second moisture retaining cap configured to cover the second head, the multiple heads may be configured to eject the liquid in an ejection region along the first direction, the suction cap, the first moisture retaining cap, and the second moisture retaining cap may be provided outside the ejection region so as to be arranged in the first direction, the suction cap may be provided at a position shifted toward the ejection region from the first moisture retaining cap and the second moisture retaining cap in the first direction.

According to the configuration described above, the region where the suction cap is provided is located between the ejection region and the region where the first moisture retaining cap and the second moisture retaining cap are provided. The step of suctioning the liquid discharged from the first head and the second head can thus be efficiently executed between the step of ejecting the liquid from the first head and the second head and the step of keeping the first head and the second head moisturized. The liquid can therefore be efficiently and appropriately received.
(D) The liquid ejecting apparatus described above may further include an elevator configured to lift and lower the cap in a third direction that intersects with the first direction and the second direction; and a controller configured to control the carriage, the mover, and the elevator, the controller may be configured to lift the cap so as to cover the first head with the cap positioned at the first position and the carriage so moved that the cap faces the first head in the third direction, then cause the cap to receive the liquid suctioned by the suction pump, lower the cap in the third direction, and then lift the cap so as to cover the second head with the cap positioned at the second position and the carriage so moved that the cap faces the second head.

According to the configuration described above, the step of suctioning the liquid discharged from the first head and the step of suctioning the liquid discharged from the second head can be efficiently executed. The liquid can therefore be efficiently and appropriately received.
(E) The liquid ejecting apparatus described above may include a first suction cap configured to receive the liquid suctioned by the suction pump, the first suction cap may be configured not to move in the second direction, the cap may be a second suction cap, the multiple heads may include a third head provided so as to be arranged with respect to the first head and the second head in the first direction, the first head and the second head may be configured to eject a first liquid as the liquid, the third head may be configured to eject a second liquid as the liquid, the first suction cap may be configured to receive the second liquid discharged from the third head, and the second suction cap may be configured to receive the first liquid discharged from the first head and the second head.

According to the configuration described above, using the first suction cap and the second suction cap allows separate reception of the first liquid discharged from the first head and the second head and the second liquid discharged from the third head. Therefore, even when the first liquid and the second liquid are received, the liquid can be appropriately received.
(F) In the liquid ejecting apparatus described above, the mover may include a guide rail configured to guide movement of the cap in the second direction, and the guide rail may be provided at a position where the guide rail overlaps with the cap in the plan view.

According to the configuration described above, the guide rail is provided at a position where the guide rail overlaps with the cap in the plan view. The thus provided guide rail, which moves the cap along the second direction, can suppress an increase in the size of the liquid ejecting apparatus and can cause the cap to appropriately receive the liquid.
(G) In the liquid ejecting apparatus described above, the mover may include a cam configured to move the cap in the second direction, and a drive source configured to rotate the cam. According to the configuration described above, the same advantages as those in (A) can be provided.
(H) The liquid ejecting apparatus described above may include a detector configured to detect a position of the cap, and the cap may be moved by the mover based on a result of the detection performed by the detector.

According to the configuration described above, the cap is moved based on the result of the detection of the position of the cap. The liquid can therefore be appropriately received by precisely moving the suction cap along the second direction.

What is claimed is:

1. A liquid ejecting apparatus comprising:
multiple heads configured to eject a liquid onto a medium;
a carriage configured to incorporate the multiple heads and move the multiple heads along a first direction;
a cap configured to receive the liquid discharged from the multiple heads; and
a mover configured to move the cap along a second direction that intersects with the first direction in a plan view,
wherein the multiple heads include a first head and a second head that is arranged with respect to the first head in the first direction and provided at a position different from the first head in the second direction, and
the mover is configured to position the cap at a first position to cause the cap to receive the liquid discharged from the first head, and position the cap at a second position different from the first position in the second direction to cause the cap to receive the liquid discharged from the second head.

2. The liquid ejecting apparatus according to claim 1, further comprising:
a suction pump configured to suction the liquid inside the cap; and
a channel configured to couple the cap to the suction pump,
wherein the cap is a suction cap configured to receive the liquid suctioned by the suction pump.

3. The liquid ejecting apparatus according to claim 2, further comprising:
a first moisture retaining cap configured to cover the first head; and
a second moisture retaining cap configured to cover the second head,
wherein the multiple heads are configured to eject the liquid in an ejection region along the first direction,
the suction cap, the first moisture retaining cap, and the second moisture retaining cap are provided outside the ejection region so as to be arranged in the first direction, and
the suction cap is provided at a position shifted toward the ejection region from the first moisture retaining cap and the second moisture retaining cap in the first direction.

4. The liquid ejecting apparatus according to claim 2, further comprising:
an elevator configured to lift and lower the cap in a third direction that intersects with the first direction and the second direction; and
a controller configured to control the carriage, the mover, and the elevator,
wherein the controller is configured to lift the cap so as to cover the first head with the cap positioned at the first position and the carriage so moved that the cap faces the first head in the third direction, then cause the cap to receive the liquid suctioned by the suction pump, lower the cap in the third direction, and then lift the cap so as to cover the second head with the cap positioned at the second position and the carriage so moved that the cap faces the second head.

5. The liquid ejecting apparatus according to claim 2, further comprising
a first suction cap configured to receive the liquid suctioned by the suction pump,
wherein the first suction cap is configured not to move in the second direction,
the cap is a second suction cap,
the multiple heads include a third head provided so as to be arranged with respect to the first head and the second head in the first direction,
the first head and the second head are configured to eject a first liquid as the liquid,
the third head is configured to eject a second liquid as the liquid,
the first suction cap is configured to receive the second liquid discharged from the third head, and
the second suction cap is configured to receive the first liquid discharged from the first head and the second head.

6. The liquid ejecting apparatus according to claim 1,
wherein the mover includes a guide rail configured to guide movement of the cap in the second direction, and
the guide rail is provided at a position where the guide rail overlaps with the cap in the plan view.

7. The liquid ejecting apparatus according to claim 1,
wherein the mover includes a cam configured to move the cap in the second direction, and a drive source configured to rotate the cam.

8. The liquid ejecting apparatus according to claim 1, further comprising
a detector configured to detect a position of the cap,
wherein the cap is moved by the mover based on a result of the detection performed by the detector.
